(19) United States
(12) Patent Application Publication
(10) Pub. No.: US 2026/0159122 A1
(43) Pub. Date: Jun. 11, 2026

(54) VEHICLE CONTROL DEVICE AND METHOD

(71) Applicants: Hyundai Motor Company, Seoul (KR); Kia Corporation, Seoul (KR)

(72) Inventor: Jong Won Kim, Hwaseong-Si (KR)

(21) Appl. No.: 19/249,456

(22) Filed: Jun. 25, 2025

(30) Foreign Application Priority Data
Dec. 10, 2024 (KR) 10-2024-0182435

(51) Int. Cl. B60W 60/00; B60W 50/14

(52) U.S. Cl. CPC B60W 60/001; B60W 50/14; B60W 2050/146; B60W 2556/45

(57) ABSTRACT

There is provided a vehicle control device including a sensor configured to detect vehicle driving information of the vehicle and object recognition information. The device may include: a transceiver; a processor; and a memory storing at least one instruction that, when executed by the processor communicating with the memory, is configured to cause the device to: control, based on the vehicle driving information and the object recognition information, an autonomous driving operation of the vehicle; based on a determination that an execution of the autonomous driving operation is not feasible, transmit, via the transceiver to a server, request information comprising the vehicle driving information and the object recognition information; and receive, via the transceiver from the server, planned driving route information corresponding to the request information. The planned driving route information may indicate an adjusted autonomous driving path associated with the location of the vehicle.

### CROSS-REFERENCE TO RELATED APPLICATION

This application claims priority to Korean Patent Application No. 10-2024-0182435, filed on Dec. 10, 2024, the disclosure of which is incorporated herein by reference in its entirety.

### FIELD

The present disclosure relates to a vehicle control device and method.

### BACKGROUND

An advanced driver assistance system (ADAS) or autonomous driving establishes a driving strategy based on preset rules in a given driving environment and performs control operations of a vehicle accordingly. However, since the driving environment in the real world is so diverse and constantly changing, there may be limits to establishing the driving strategy based on the preset rules.

For example, in complex driving situations or when a vehicle deviates from a predefined driving plan, since a driving strategy may be difficult to establish when an edge computing resource of a vehicle is beyond its limit, the vehicle may require an emergency stop by, for example, pulling over to a shoulder of the road.

As described above, the process of establishing a driving strategy and performing control operations in an ADAS or autonomous vehicle is very complex, and various technical and environmental problems may occur. These problems may ultimately compromise the stability and reliability of the vehicle, and may be obstacles to implementing full autonomous driving.

### SUMMARY

The present disclosure is directed to providing a vehicle control device and method capable of receiving a driving route strategy in text form from a server and responding to a complex driving situation or a case where driving deviates from a predefined scenario.

The present disclosure is also directed to providing a vehicle control device and method capable of generating a route in text form and establishing a sequential driving route strategy according to the route.

The present disclosure is also directed to providing a vehicle control device and method capable of learning and computing large-scale data on a driving route strategy using a server.

According to one or more example embodiments of the present disclosure, a device for controlling a vehicle may include: a sensor configured to detect vehicle driving information of the vehicle and object recognition information. The vehicle driving information may indicate a location of the vehicle. The object recognition information may indicate at least one object located within a threshold distance from the vehicle. The device may further include; a transceiver; a processor; and a memory storing at least one instruction that, when executed by the processor communicating with the memory, is configured to cause the device to: control, based on the vehicle driving information and the object recognition information, an autonomous driving operation of the vehicle; based on a determination that an execution of the autonomous driving operation is not feasible, transmit, via the transceiver to a server, request information including the vehicle driving information and the object recognition information; and receive, via the transceiver from the server, planned driving route information corresponding to the request information. The planned driving route information may indicate an adjusted autonomous driving path associated with the location of the vehicle.

The at least one instruction, when executed by the processor communicating with the memory, may be configured to cause the device to generate a control signal for controlling an updated autonomous driving operation of the vehicle using the planned driving route information.

The at least one instruction, when executed by the processor communicating with the memory, may be configured to cause the device to: convert the planned driving route information into at least one output format among a letter, a symbol, a figure, and a number; and display, on a display device of the vehicle, the converted planned driving route information.

The planned driving route information may be provided by the server using a large language model (LLM) model.

The LLM model may be configured to perform a training process, based on the vehicle driving information and the object recognition information, to generate the planned driving route information.

The planned driving route information may include: a proposed route in text form, and driving operation control signals in text form arranged along the proposed route.

The planned driving route information may include first-type planned driving route information associated with navigating driving control and second-type planned driving route information associated with responsive driving control.

The at least one instruction, when executed by the processor communicating with the memory, may be configured to cause the device to: determine, based on the vehicle driving information and the object recognition information, a performance probability for the autonomous driving operation; and transmit, based on the performance probability being less than a threshold value, the request information to the server via the transceiver.

The at least one instruction, when executed by the processor communicating with the memory, may be configured to cause the device to: determining, based on a predetermined condition and using the vehicle driving information and the object recognition information, whether it is possible to perform the autonomous driving operation.

The at least one instruction, when executed by the processor communicating with the memory, may be configured to cause the device to transmit, based on a computing resource for performing the autonomous driving operation exceeding a threshold value, the request information to the server via the transceiver.

According to one or more example embodiments of the present disclosure, a method performed by an apparatus of a vehicle may include: controlling an autonomous driving operation of the vehicle; and detecting, via a sensor of the vehicle, vehicle driving information of the vehicle and object recognition information. The vehicle driving information may indicate a location of the vehicle. The object recognition information may indicate at least one object located within a threshold distance from the vehicle. The method may further include: determining, based on the vehicle driving information and the object recognition information, a value indicating a possibility of performing an autonomous driving operation control; based on a determination that performance of the autonomous driving operation control is not feasible, transmitting, via a transceiver of the vehicle to a server, request information including the vehicle driving information and the object recognition information; and receiving, via the transceiver from the server, planned driving route information corresponding to the request information. The planned driving route information may indicate an adjusted autonomous driving path associated with the location of the vehicle.

The method may further include, after the receiving of the planned driving route information, generating a control signal for controlling an updated autonomous driving operation of the vehicle using the planned driving route information.

The method may further include, after the receiving of the planned driving route information: converting the planned driving route information into at least one output format among a letter, a symbol, a figure, and a number; and displaying, on a display device of the vehicle, the converted planned driving route information.

The planned driving route information may be provided by the server using an LLM model.

The LLM model may be configured to perform a training process, based on the vehicle driving information and the object recognition information, to generate the planned driving route information.

Determining the possibility of performing may include: determining, based on the vehicle driving information and the object recognition information, a performance probability for the autonomous driving operation control; and determining, based on the performance probability being less than a threshold value, that performance of the autonomous driving operation control is not feasible.

Transmitting the request information may include transmitting the request information, to the server via the transceiver, based on the performance probability being less than the threshold value.

Determining the performance probability may include determining, based on a predetermined condition and using the vehicle driving information and the object recognition information, whether it is possible to perform the autonomous driving operation control.

Determining the possibility of performing may include: comparing a computing resource for performing the autonomous driving operation control with a threshold value; and

determining, based on the computing resource exceeding the threshold value, that performance of the autonomous driving operation control is not feasible.

Transmitting the request information may include transmitting the request information based on the computing resource exceeding the threshold value.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a view illustrating a vehicle transmitting and receiving data by communicating with other devices;

FIG. 2 is a diagram showing modules constituting a vehicle;

FIG. 3 is a diagram for describing the operation of the vehicle;

FIG. 4 is a diagram for describing the operation of a server;

FIG. 5 is a view for describing the concept of planned driving route information.

FIGS. 6A, 6B, and 6C are diagrams for describing the operation of a processor;

FIG. 7 is a flowchart of a method of controlling a vehicle;

FIG. 8 is a flowchart of the operation of a processor; and

FIG. 9 is a flowchart of a method of controlling a vehicle.

### DETAILED DESCRIPTION

Hereinafter, one or more example embodiments of the present disclosure will be described in detail with reference to the accompanying drawings.

However, the technical idea of the present disclosure is not limited to the example embodiments to be described but may be implemented in various different forms, and within the scope of the technical idea of the present disclosure, one or more among components in the example embodiments may be used by being selectively combined and substituted.

Further, unless specifically defined and described, terms used in the example embodiments of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the example embodiments of the present disclosure are for the purpose of describing the example embodiments only and are not intended to limit the disclosure.

In the present specification, the singular forms may include the plural forms unless the context clearly dictates otherwise. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, when describing components of example embodiments of the present disclosure, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., one or more features of a server-assisted vehicle control device, a determination that an execution of an autonomous driving operation is not feasible, etc.) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., server-assisted vehicle control device) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., server-assisted vehicle control device) described herein.

Minimum risk maneuver (MRM) operation(s) may also be controlled, for example, based on one or more features (e.g., one or more features of a server-assisted vehicle control device, a determination that an execution of an autonomous driving operation is not feasible, etc.) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., one or more features of a server-assisted vehicle control device, a determination that an execution of an autonomous driving operation is not feasible, etc.) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

An autonomous driving level and/or autonomous driving activation/deactivation may also be controlled, for example, based on one or more features (e.g., one or more features of a server-assisted vehicle control device, a determination that an execution of an autonomous driving operation is not feasible, etc.) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., one or more features of a server-assisted vehicle control device, a determination that an execution of an autonomous driving operation is not feasible, etc.) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

Hereinafter, one or more example embodiments will be described in detail with reference to the accompanying drawings, but the same or corresponding components are denoted by the same reference numerals regardless of the drawing numbers, and redundant descriptions thereof will be omitted.

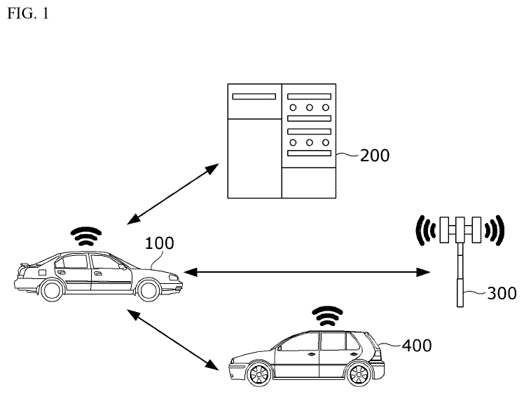

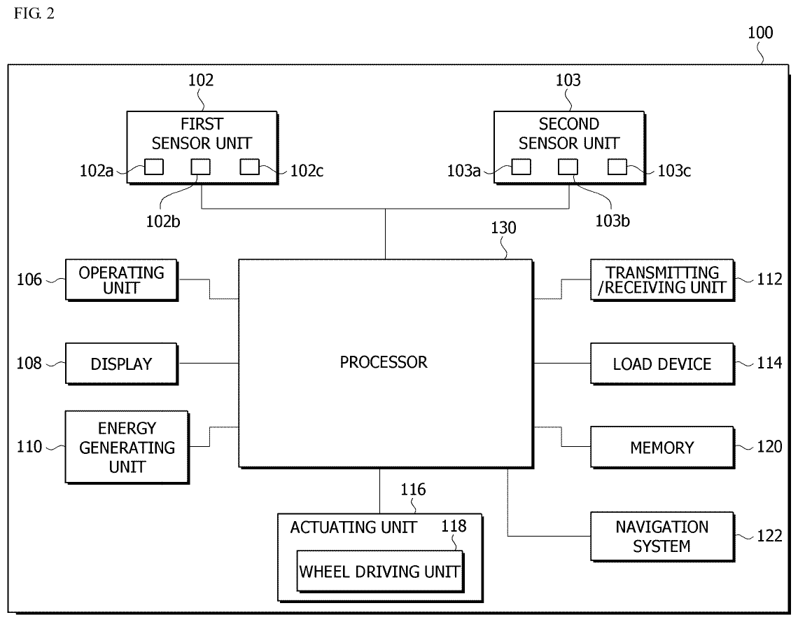

Hereinafter, a vehicle will be described with reference to FIGS. 1 and 2. FIG. 1 is a view illustrating a vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas in a liquefied state, for example. Here, one example of the gas may be hydrogen. However, the gas is not limited thereto, and various gases may be applicable. In the case of fossil energy, the vehicle 100 is driven based on fuel such as gasoline, diesel or liquefied gas, and may be equipped with an internal combustion engine that drives an actuating unit (also referred to as an actuator) 116 by combustion of the fuel. The engine may be included in an energy generating unit (also referred to as a generator, a power generator, an energy generator, etc.) 110 in terms of providing a driving rotational force of wheels to a wheel driving unit (e.g., a powertrain) 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but the present disclosure may also be applied to air mobility devices such as an advanced air mobility (AAM), aircraft, or the like, and water mobility devices such as ships, submarines, or the like.

The vehicle 100 may be autonomously controlled and driven, and autonomous driving may be classified into an advanced driver assistance system (ADAS), whose driver automation level may be, for example, 1 or 2 or an automated driving system (ADS) whose driver automation level may be between 3 and 5.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a road side unit (RSU). The ITS device 300 may assist the user in driving his or her own vehicle or support autonomous driving of the vehicle 100 by exchanging vehicle recognition data, driving operation control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a Wi-Fi communication network, a WAVE communication network, or the like, for communicating with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described example embodiments.

FIG. 2 is a diagram showing modules constituting a vehicle.

The vehicle 100 may include a sensor 102, an operating unit 106, a display 108, a load device (also referred to as a load or an electrical load) 114, and a transceiver unit (also referred to a communicator, a communication interface, a transceiver, etc.) 112.

The sensor 102 may be provided with various types of detectors to detect various states and situations occurring in an external environment, an internal system, user operation, and a boarding space of the vehicle 100.

Specifically, the first sensor 102 may be provided with an externally oriented camera 104a, a lidar sensor 104b, a radar sensor 104c, and the like, to recognize dynamic and static objects present outside the vehicle 100. The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate three-dimensional (3D) spatial information that identifies at least a shape of the external object. In order to ascertain (e.g., detect) the presence of an external object and its relative distance, speed, direction, or the like, the radar sensor 104c may emit radio waves of a specific frequency around the vehicle 100 and generate radar data through radio waves reflected from the external object. In the present disclosure, the sensor 102 is illustrated as having the lidar sensor 104b, but in other examples, the lidar sensor 104b may not be mounted.

The first sensor 102 may generate object recognition information based on sensing data. The object recognition information may include information on the presence of an object, position information about the object, information on a distance between the vehicle 100 and the object, and information on a relative speed between the vehicle 100 and the object. External objects may be various objects related to the operation of the vehicle 100.

A second sensor 103 may be provided with a positioning sensor 104d, a wheel sensor 104e, an attitude sensor 104f, and the like, to confirm (e.g., detect, identify, sense, determine, etc.) its own location, speed, driving attitude, and the like. The attitude sensor 104f may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (e.g., longitudinal direction or x-axis), acceleration in a lateral direction (e.g., y-axis), and acceleration in a height direction (e.g., z-axis) of the vehicle 100, and a yaw, a pitch, and a roll as the angular velocity of the vehicle.

The second sensor 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include route information. The route information may refer to information generated based on a destination input by a vehicle user through the operating unit (also referred to as a user interface, a control panel, a dashboard, an instrument cluster, an instrument panel, etc.) 106. The route information may refer to information that indicates a traveling route from a current position of a host vehicle to a destination on a map, for example, after the destination has been set. If no destination is set, the route information may refer to information including a road on which the host vehicle is currently traveling and a future driving route including one or more roads. The route information may indicate which driving lane(s) for the vehicle to drive on and/or specific path(s) for the vehicle to follow along the road.

The operating unit 106 may be configured as a module (e.g., implemented as hardware, software, or a combination of both) that is controlled by the user for driving. The operating unit 106 may include any a user interface, a control panel, a dashboard, an instrument cluster, an instrument panel, etc. that a user (e.g., a driver or a passenger) may interact with to operate or manipulate one or more aspects of the vehicle 100. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that may be touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input to receive a driver's request to instruct the processor 130.

The load device 114 may be mounted on the vehicle 100 and may be a type of non-driving electrical device excluding a driving power system such as the wheel driving unit 118 or the like. The load device 114 may be an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transceiver unit 112 may support mutual communication with the server 200, the ITS device 300, surrounding vehicles 300, and the like. The transceiver unit 112 may include a module that processes, for example, cellular communication, WAVE, DSRC communication, and the like. In the present disclosure, the transceiver unit 112 may transmit data generated or stored while driving to the server 200 and receive data and software modules transmitted from the server 200. The transceiver unit 112 may support communication with an electronic device carried by an occupant inside the vehicle 100. In the present disclosure, the vehicle 100 may transmit and receive data utilized in a method according to the present disclosure to and from the outside through the transceiver unit 112.

For example, the transceiver unit 112 may receive traffic signal information from a traffic signal controller and provide the traffic signal information to the processor 130. In addition, the transceiver unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor 102, the operating unit 106, the display 108, the load device 114, and the transceiver unit 112, but is not limited thereto, and may include various components that implement sensing, interface, communication, and convenience functions, excluding components directly involved in driving operations. If the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. If the vehicle 100 is driven based on fossil energy, the energy generating unit 110 may be configured as an internal combustion engine. In addition, if the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. If the vehicle 100 is operated based on electrical energy, the actuating unit 116 may include an assembly for transmitting the requested driving operation to the wheel driving unit 118. If the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. If the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit (also referred to as a navigation system) 122 may provide navigation information. The navigation information may include at least one of map information, set destination information, route information according to a set destination, information on various objects on the route, lane information, and current vehicle position information.

The navigation unit 122 may receive information from an external device through the transceiver unit 112 and update previously stored information. The navigation unit 122 may be classified as a sub-component of the operating unit 106.

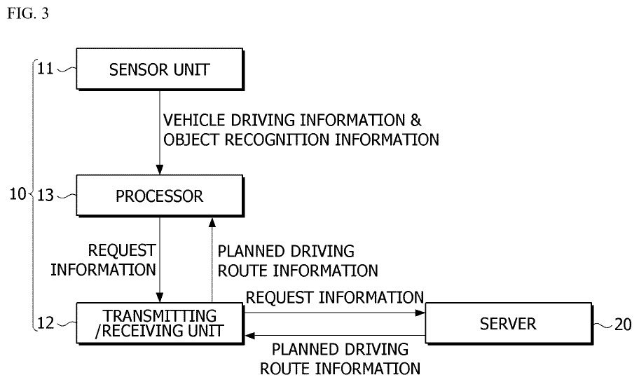

FIG. 3 is a diagram for describing the operation of the vehicle. Referring to FIG. 3, a vehicle control device 10 may include a sensor 11, a transceiver unit (also referred to as a communicator, a communication interface, a transceiver, etc.) 12, and a processor 13. The vehicle 100 may perform one or more operations described herein, for example, based on one or more conditions (e.g., a speed of the vehicle 100 is less than a threshold speed, one or more objects are blocking at least a portion of a lane on an autonomous driving path, a hazardous environment has been detected, a police officer is controlling a traffic flow, an emergency vehicle is detected, etc.) are satisfied.

The sensor 11 may detect vehicle driving information and object recognition information. The sensor unit 11 may mean a configuration including the first sensor unit and the second sensor unit in FIG. 2.

The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include route information. The route information may refer to information generated based on a destination input by a vehicle user through the operating unit 106. The route information may refer to information that indicates a traveling route from a current position of a host vehicle to a destination on a map, for example, if the destination has been set. If no destination is set, the route information may refer to information including a road on which the host vehicle is currently traveling and a future driving route including the road. The route information may include driving road characteristic information that distinguishes between highways and general roads, and driving area characteristic information such as a speed limit, a child/elderly protection zone, a no-parking zone, and the like.

The object recognition information may include information on the presence of an object, location information about the object, information on a distance between the vehicle 100 and the object, and information on a relative speed between the vehicle 100 and the object. External objects may be various objects related to the operation of the vehicle 100. For example, the external objects may include other vehicles, lane lines, signs, crosswalks, traffic lights, pedestrians, and surrounding vehicles.

If it is not feasible (e.g., not possible) to perform driving operation control (e.g., autonomous driving operation control), the transceiver unit 12 may transmit request information including vehicle driving information and object recognition information to a server 20. The transceiver unit 12 may have the same configuration as the transceiver unit in FIG. 2.

For example, the request information may mean data in query form that processes time information, country and vehicle type information, vehicle driving information, and object recognition information into text form and divides and queries necessary planned driving route information into long-term and short-term.

The transceiver unit 12 may receive the planned driving route information through a question-and-response process in the form of conversation with the server 20 through the request information in query form.

The driving operation control may refer to any action related to recognizing an object while driving or controlling the operation of the vehicle through a certain action (steering operation, acceleration/deceleration, or the like), for example, if an event occurs.

For example, the driving operation control may mean driving dynamic task (DDT). The driving operation control may include operational control including vehicle speed, acceleration, deceleration, and steering control, tactical decisions for decision-making such as selecting a driving route, changing lanes, waiting at traffic signals, or the like, and strategic planning responsible for setting a destination and planning a long-term route. A detailed description of the driving operation control will be described below along with the operation of the processor 13.

In addition, the transceiver unit 12 may receive the planned driving route information in text form corresponding to the request information from the server 20. A detailed description of the planned driving route information will be described below along with the operation of the server 20.

The server 20 may generate the planned driving route information corresponding to the request information from the transceiver unit 12. The server 20 may transmit the generated planned driving route information to the transceiver unit 12.

If the server 20 receives the request information in the query form, the server 20 may generate the planned driving route information corresponding to the request information based on learning results of a large language model (LLM) model.

The LLM model may be a large-scale language model with many parameters and may learn patterns and meaning from text data. The LLM model may perform various tasks according to inputs called prompts.

The LLM model may mean a deep learning architecture that performs long-term context recognition. The LLM model may calculate which words are important in input text and assign weights to the words. The LLM model may generate the planned driving route information in the form of text tokens as an appropriate output for the input in the form of an encoder-decoder.

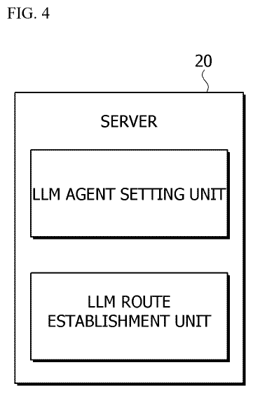

FIG. 4 is a diagram for describing the operation of a server. Referring to FIG. 4, the server 20 may generate planned driving route information using a large language model (LLM) model. The LLM model may include an LLM agent setting unit (also referred to as an LLM agent selector) and an LLM route establishment unit (also referred to as an LLM route selector).

The LLM agent setting unit may set roles for generating planned driving route information according to learning results and define input and output data. The input data may be defined in the form of Json-type data and video frames, but is not limited thereto.

The output data may be defined in the form of CSV Table or Plain Text, but is not limited thereto.

The LLM route establishment unit may learn vehicle driving information and object recognition information collected from a plurality of vehicles and propose a driving route for performing the driving operation control given in a complex driving environment. If the LLM route establishment unit receives request information, the LLM route establishment unit may list the proposed routes in chronological order by latitude and longitude coordinates based on a current location of a host vehicle, and generate and output information for controlling a speed and steering angle for each coordinate. In addition, the LLM route establishment unit may analyze information received through the transceiver unit 12, and organize the analyzed information in text form and provide the information in text form to the transceiver unit 12. Through this process, the LLM server 20 using the LLM model may receive the request information in a question-and-response form with the transceiver unit 12, generate planned driving route information corresponding to the request information, and provide the generated planned driving route information to the transceiver unit 12.

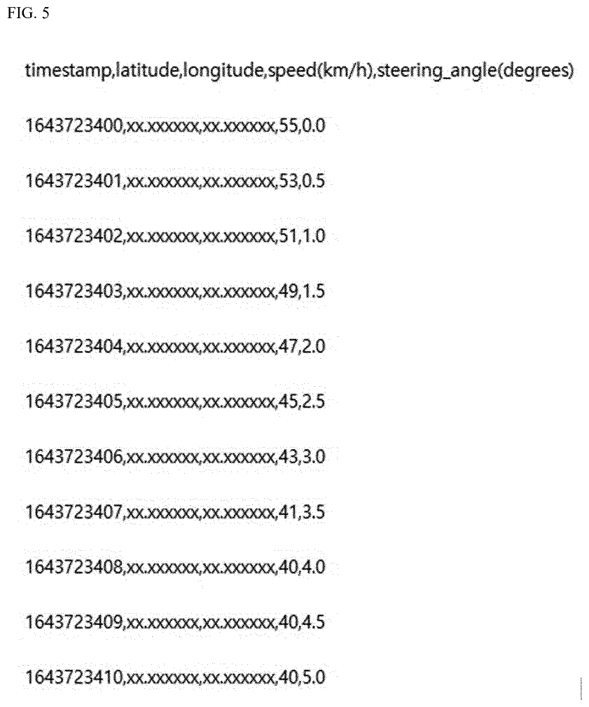

FIG. 5 is a view for describing the concept of planned driving route information. Referring to FIG. 5, the planned driving route information generated by the LLM model may include a proposed route and driving operation control signals in text form arranged along the proposed route.

In addition, the planned driving route information may include long-term driving information and short-term driving information. The planned driving route information may indicate future locations along the proposed route as coordinates based on the current location of the vehicle, and indicate driving operation control signals for sequentially controlling the operation of the vehicle in text form along to the indicated coordinates. As shown in FIG. 5, the planned driving route information of the server 20 may be configured by sequentially listing a plurality of pieces of text information made up of a timestamp, a latitude, a longitude, a speed (km/h), and a steering angle (steering_angle (degrees) in chronological order. Here, the time stamp may mean time information for performing a driving control operation of the vehicle, the latitude and longitude may mean information indicating the proposed driving route of the vehicle as coordinates, and the speed and steering angle may mean a driving operation control signal for controlling the operation of the vehicle.

The processor 13 may perform driving operation control using vehicle driving information and object recognition information. The processor 13 may have the same configuration as the processor in FIG. 2.

The processor 13 may generate a control signal for controlling the vehicle using the planned driving route information. The processor 13 may generate a control signal for controlling the operation of the vehicle using the planned driving route information generated using the vehicle driving information and the object recognition information or the planned driving route information received from the server 20. The vehicle control signal may include a steering control angle and acceleration/deceleration control amount according to the planned driving route information.

The processor 13 may perform long-term driving operation control such as straight driving, branching, merging, left turning, right turning, U-turn, crossing an intersection, crossing a roundabout, and the like, and short-term driving operation control such as responding to traffic lights, cutting in, yielding, avoiding parked vehicles on the shoulder, responding to traffic guidance, responding to emergency vehicles, and the like, using the vehicle driving information and the object recognition information.

The processor 13 may combine object recognition information to generate one piece of integrated environment information. For example, if the camera recognizes a pedestrian, the processor 13 may verify the distance using radar to generate environmental information with improved accuracy.

The processor 13 may compute a current location and direction of the vehicle by combining location information about the vehicle and IMU data.

The processor 13 may calculate a driving route to a destination according to the location and direction of the vehicle and establish a detailed route to avoid dynamic obstacles. The processor 13 may use map information and the navigation system to set a global route to the destination and calculate a real-time local route plan for obstacle avoidance in a dynamic environment.

For example, the processor 13 may set the global route using the A* algorithm or the Dijkstra algorithm, and calculate the local route plan using the rapidly-exploring random tree (RRT) or the Bezier curve.

The processor 13 may control the speed of the vehicle through proportional-integral-derivative control (PID control) to move the vehicle along the planned route, and control the steering angle of the vehicle through model predictive control (MPC).

The processor 13 may detect surrounding objects according to environmental information that integrates the object recognition information and predict how the surrounding objects will move in the future. For example, the processor 13 may recognize a pedestrian, a vehicle, and the like, using a real-time object detection deep learning-based algorithm, and predict movement routes of the objects using a probabilistic prediction model.

The processor 13 may determine what operation the vehicle will take based on the vehicle driving information and the movement routes of the objects, and generate the determined operation as the planned driving route information.

The processor 13 may continuously monitor and adjust the detection results and control results of the sensor 11 during driving. For example, the processor 13 may recalculate the route and modify control parameters if a road condition changes.

In this way, the driving operation control may be a process that includes all of the recognition, determination, and control processes of the vehicle, and the processor 13 may process sensor data in real time, plan a route, and respond to an emergency situation in real time.

The processor 13 may determine whether it is possible to perform driving operation control on its own, and if it is determined not to be possible, the processor 13 may request the server 20 to transmit planned driving route information.

For example, the processor 13 may determine a performance probability for the driving operation control using the vehicle driving information and the object recognition information, and may transmit the request information to the server 20 through the transceiver unit 12 if the performance probability is less than a preset threshold probability. If a probability that the processor 13 may perform the driving operation control on its own is not high (e.g., below a threshold value) or if it is not feasible (e.g., not possible) to perform the driving operation control, the processor 13 may request the server 20 to generate the planned driving route information.

The processor 13 may use the vehicle driving information and the object recognition information to determine whether it is possible to perform the driving operation control according to a preset (e.g., predetermined, prewritten, etc.) rule and calculate the performance probability. The processor 13 may determine whether a current driving environment of the vehicle according to the vehicle driving information and the object recognition information is controllable based on the preset rule. The processor 13 may calculate a low performance probability if the driving environment of the vehicle is not defined by the preset rule or if a driving route strategy may not be established according to the preset rule. That is, the processor 13 may perform numerical calculation on whether the current driving environment of the vehicle may be analyzed through the rule to calculate the performance probability.

In addition, the processor 13 may transmit the request information to the server 20 through the transceiver unit 12 if a computing resource for performing the driving operation control exceeds a reference resource. If a very complex computing process is required to analyze the vehicle driving information and the object recognition information to calculate the driving operation control, or if it is not possible to calculate the planned driving route information through its own computing resources, the processor 13 may request the server 20 to generate planned driving route information.

In addition, the processor 13 may determine the reliability of a proposed route of the planned driving route information received from the server 20. The processor 13 may determine whether it is possible to drive on the proposed route using the vehicle driving information and the object recognition information.

For example, the processor 13 may determine whether a suitable route for the vehicle to travel on the proposed route is provided and whether there are no obstacles.

For example, the processor 13 may check whether there is a possibility of collision with an external object or not if the operation of the vehicle is controlled according to the driving operation control signal.

The processor 13 may process the driving operation control signal to generate a control signal if driving on the proposed route is possible and there is no possibility of collision.

Alternatively, if driving on the proposed route is not possible, the processor 13 may regenerate the request information and transmit the regenerated request information to the server 20 through the transceiver unit 12. In this case, the processor 13 may transmit the request information together with a reason why driving on the proposed route is not possible.

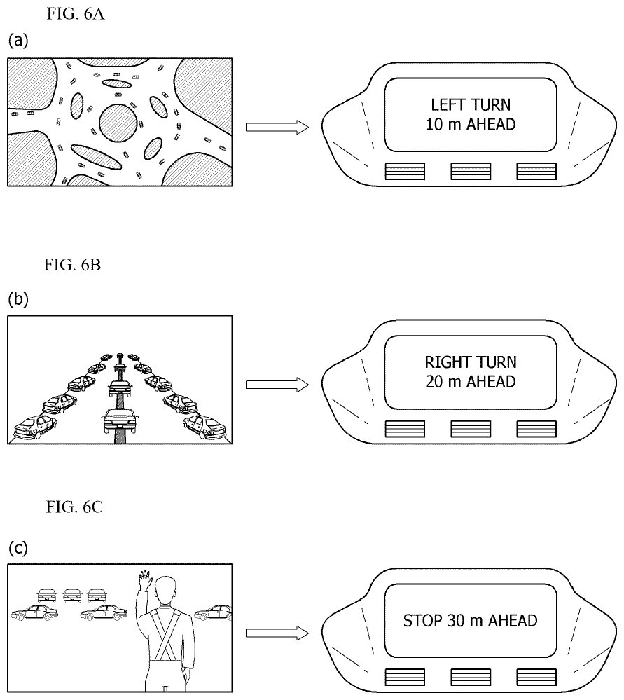

FIGS. 6A, 6B, and 6C are diagrams for describing the operation of the processor. Referring to FIGS. 6A, 6B, and 6C, the processor 13 may process (e.g., convert) planned driving route information into at least one form of a letter, a symbol, a figure, and a number and display the planned driving route information on a vehicle display. The processor 13 may display a proposed route and planned driving route information on a display such as an AVBT, instrument panel, or navigation screen provided inside the vehicle. For example, the processor 13 may display the proposed route and the planned driving route information in a pop-up form.

Referring to FIG. 6A, if an entrance and exit ramp is complex and map information is not secured in advance, the processor 13 may display the planned driving route information received from the server 20 on the vehicle display.

Referring to FIG. 6B, if driving in a lane is not possible due to parking on the shoulder, the processor 13 may display the planned driving route information received from the server 20 on the vehicle display.

Referring to FIG. 6C, if traffic guidance by manpower is being performed on the road due to an abnormality in a traffic signal controller or excessive traffic volume, the processor 13 may display the planned driving route information received from the server 20 on the vehicle display.

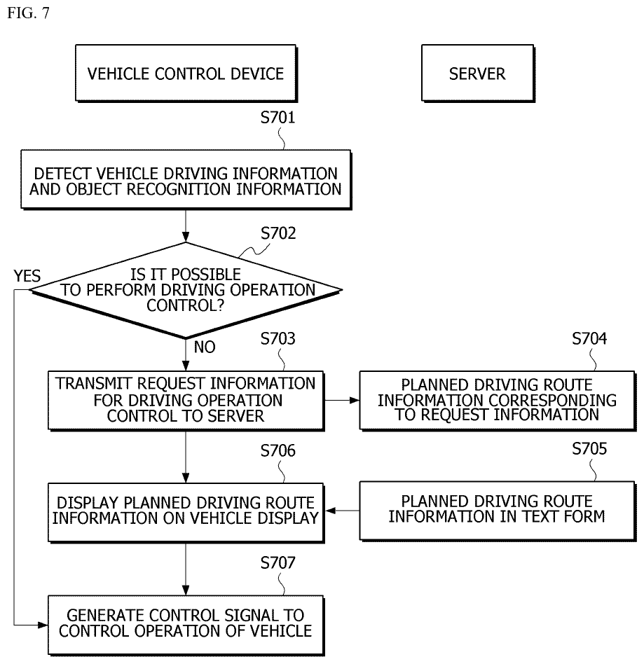

FIG. 7 is a flowchart of a method of controlling a vehicle. Referring to FIG. 7, the sensor detects vehicle driving information and object recognition information (S701).

The processor may determine the possibility of performing driving operation control using the vehicle driving information and the object recognition information (S702).

If it is determined that it is not possible to perform driving operation control, the transceiver unit transmits request information including the vehicle driving information and the object recognition information to the server (S703).

If it is determined that it is possible to perform the driving operation control, the processor generates a control signal on its own to control the operation of the vehicle (S707).

The server uses the LLM model to generate planned driving route information corresponding to the request information (S704).

The transceiver unit receives the planned driving route information in text form corresponding to the request information from the server (S705).

The processor may process the planned driving route information into at least one of a letter, a symbol, a figure, and a number and displays the processed planned driving route information on the vehicle display (S706).

Then or simultaneously, the processor generates a control signal to control the vehicle using the planned driving route information to control the operation of the vehicle (S707).

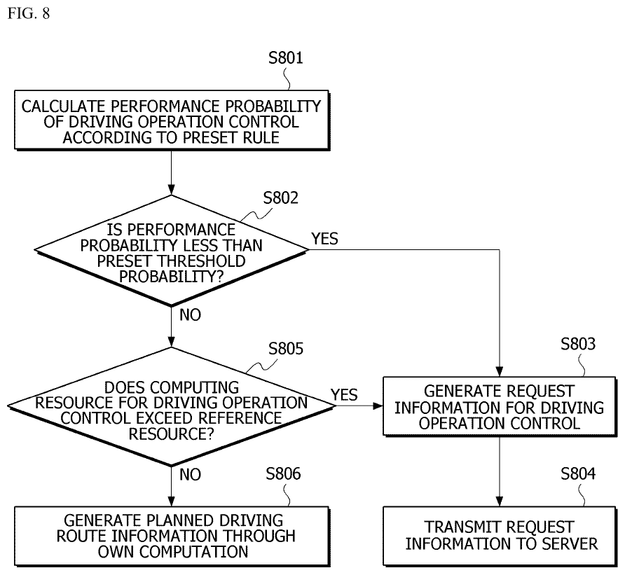

FIG. 8 is a flowchart of the operation of the processor. Referring to FIG. 8, the processor may determine whether it is possible to perform the driving operation control according to a preset rule through vehicle driving information and object recognition information, and calculates a performance probability (S801).

The processor generates request information for requesting planned driving route information if the performance probability is less than a preset threshold probability (S802 and S803).

The transceiver unit transmits the request information generated by the processor to the server (S804).

If the performance probability is equal to or greater than a preset threshold probability, the processor may compare a computing resource for performing driving operation control with a reference resource (S805).

If the computing resource exceeds the reference resource, the processor generates request information for requesting planned driving route information (S803).

The transceiver unit transmits the request information generated by the processor to the server (S804).

If the computing resource does not exceed the reference resource, the processor generates the planned driving route information through its own computation (S806).

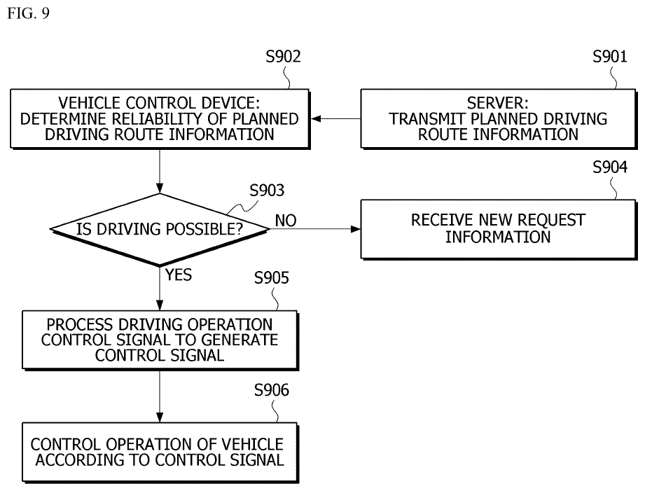

FIG. 9 is a flowchart of a method of controlling a vehicle. Referring to FIG. 9, the server transmits planned driving route information corresponding to request information to the transceiver unit (S901).

The processor may determine the reliability of the planned driving route information. The processor uses vehicle driving information and object recognition information to determine whether it is possible to drive on a proposed route. That is, the processor may check whether a suitable route for the vehicle to travel on the proposed route is provided according to a driving operation control signal, whether there are no obstacles, and/or whether there is a possibility of collision or not (S902).

The processor may determine whether driving according to the planned driving route information is possible through reliability evaluation (S903).

If driving on the proposed route is not possible, the processor may regenerate the request information and transmits the regenerated request information to the server through the transceiver unit (S904).

If driving on the proposed route is possible, the processor may process the driving operation control signal to generate a control signal (S905).

The processor controls the operation of the vehicle according to the control signal (S906).

The term “unit” used in the example embodiments refers to software component or hardware components such as a field-programmable gate array (FPGA) or an application specific integrated circuit (ASIC), and “unit” performs certain functions. However, the “unit” is not limited to software or hardware. The “unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “unit” may be combined into smaller numbers of components and “units,” or may be further divided into additional components and “units.” Furthermore, the components and “units” may be implemented to reproduce one or more CPUs in a device or a security multimedia card.

According to an aspect of the present disclosure, there is provided a vehicle control device including a sensor unit configured to detect vehicle driving information and object recognition information, a processor configured to perform driving operation control using the vehicle driving information and the object recognition information, and a transceiver unit configured to, based on a determination that an execution of the driving operation control is not possible, transmit request information including the vehicle driving information and the object recognition information to a server and receive planned driving route information corresponding to the request information from the server.

The processor may generate a control signal for controlling a vehicle using the planned driving route information.

The processor may process the planned driving route information into at least one form among a letter, a symbol, a figure, and a number and displays the processed planned driving route information on a vehicle display.

The server may generate the planned driving route information using a large language model (LLM) model.

The LLM model of the server may learn the vehicle driving information and the object recognition information to generate the planned driving route information.

The planned driving route information may include a proposed route and driving operation control signals in text form arranged along the proposed route.

The planned driving route information may include long-term planned driving route information and short-term planned driving route information.

The processor may determine a performance probability for the driving operation control using the vehicle driving information and the object recognition information and transmit the request information to the server through the transceiver unit when the performance probability is less than a preset threshold probability.

The processor may determine whether the driving operation control is performable according to a preset rule through the vehicle driving information and the object recognition information and calculate the performance probability.

The processor may transmit the request information to the server through the transceiver unit when a computing resource for performing the driving operation control exceeds a reference resource.

According to another aspect of the present disclosure, there is provided a method of controlling a vehicle, including detecting, by a sensor unit mounted on the vehicle, vehicle driving information and object recognition information, determining, by a processor, a possibility of performing driving operation control using the vehicle driving information and the object recognition information, transmitting, by a transceiver unit, request information including the vehicle driving information and the object recognition information to a server when it is not possible to perform the driving operation control, and receiving, by the transceiver unit, planned driving route information in text form corresponding to the request information from the server.

The method may further include, after the receiving of the planned driving route information, generating, by the processor, a control signal for controlling the vehicle using the planned driving route information.

After the receiving of the planned driving route information, the processor may process the planned driving route information into at least one form among a letter, a symbol, a figure, and a number and display the processed planned driving route information on a vehicle display.

The method may further include, after the transmitting of the request information to the server, generating, by the server, the planned driving route information using an LLM model.

The generating of the planned driving route information may include learning, by the LLM model of the server, the vehicle driving information and the object recognition information to generate the planned driving route information.

The determining of the possibility of performing may include determining a performance probability for the driving operation control using the vehicle driving information and the object recognition information and determining that it is not possible to perform the driving operation control when the performance probability is less than a preset threshold probability.

The transmitting of the request information to the server may include transmitting the request information to the server through the transceiver unit when the performance probability is less than the preset threshold probability.

The determining of the performance probability may include calculating the performance probability by determining whether it is possible to perform the driving operation control according to a preset rule through the vehicle driving information and the object recognition information.

The determining of the possibility of performing may include comparing the computing resource for performing the driving operation control with the reference resource and determining that it is not possible to perform the driving operation control when the computing resource exceeds the reference resource.

In the transmitting of the request information to the server, the request information may be transmitted to the server through the transceiver unit when the computing resource exceeds the reference resource.

With a vehicle control device and method according to the present disclosure, it is possible to establish a driving strategy capable of responding to a complex driving situation or a situation in which driving deviates from a predefined scenario.

In addition, it is possible to perform real-time generation of a route in text form and establishment of a sequential driving route strategy according to the route.

In addition, it is possible to use a server to request learning and computing of large-scale data on the driving route strategy.

In this way, it is possible to improve the stability and reliability of vehicle driving.

Although one or more example embodiments of the present disclosure have been described above, it is understood that those skilled in the art may make various changes and modifications to the present disclosure without departing from the spirit and scope of the present disclosure set forth in the claims below.

What is claimed is:

1. A device for controlling a vehicle, the device comprising:
a sensor configured to detect vehicle driving information of the vehicle and object recognition information, wherein the vehicle driving information indicates a location of the vehicle, and wherein the object recognition information indicates at least one object located within a threshold distance from the vehicle;
a transceiver;
a processor; and
a memory storing at least one instruction that, when executed by the processor communicating with the memory, is configured to cause the device to:
control, based on the vehicle driving information and the object recognition information, an autonomous driving operation of the vehicle;
based on a determination that an execution of the autonomous driving operation is not feasible, transmit, via the transceiver to a server, request information comprising the vehicle driving information and the object recognition information; and
receive, via the transceiver from the server, planned driving route information corresponding to the request information, wherein the planned driving route information indicates an adjusted autonomous driving path associated with the location of the vehicle.

2. The device of claim 1, wherein the at least one instruction, when executed by the processor communicating with the memory, is configured to cause the device to generate a control signal for controlling an updated autonomous driving operation of the vehicle using the planned driving route information.

3. The device of claim 1, wherein the at least one instruction, when executed by the processor communicating with the memory, is configured to cause the device to:
convert the planned driving route information into at least one output format among a letter, a symbol, a figure, and a number; and
display, on a display device of the vehicle, the converted planned driving route information.

4. The device of claim 1, wherein the planned driving route information is provided by the server using a large language model (LLM) model.

5. The device of claim 4, wherein the LLM model is configured to perform a training process, based on the vehicle driving information and the object recognition information, to generate the planned driving route information.

6. The device of claim 1, wherein the planned driving route information comprises:
a proposed route in text form, and
driving operation control signals in text form arranged along the proposed route.

7. The device of claim 1, wherein the planned driving route information comprises first-type planned driving route information associated with navigating driving control and second-type planned driving route information associated with responsive driving control.

8. The device of claim 1, wherein the at least one instruction, when executed by the processor communicating with the memory, is configured to cause the device to:
determine, based on the vehicle driving information and the object recognition information, a performance probability for the autonomous driving operation; and
transmit, based on the performance probability being less than a threshold value, the request information to the server via the transceiver.

9. The device of claim 8, wherein the at least one instruction, when executed by the processor communicating with the memory, is configured to cause the device to:
determining, based on a predetermined condition and using the vehicle driving information and the object recognition information, whether it is possible to perform the autonomous driving operation.

10. The device of claim 1, wherein the at least one instruction, when executed by the processor communicating with the memory, is configured to cause the device to transmit, based on a computing resource for performing the autonomous driving operation exceeding a threshold value, the request information to the server via the transceiver.

11. A method performed by an apparatus of a vehicle, the method comprising:
controlling an autonomous driving operation of the vehicle;
detecting, via a sensor of the vehicle, vehicle driving information of the vehicle and object recognition information, wherein the vehicle driving information indicates a location of the vehicle, and wherein the object recognition information indicates at least one object located within a threshold distance from the vehicle;
determining, based on the vehicle driving information and the object recognition information, a value indicating a possibility of performing an autonomous driving operation control;
based on a determination that performance of the autonomous driving operation control is not feasible, transmitting, via a transceiver of the vehicle to a server, request information comprising the vehicle driving information and the object recognition information; and
receiving, via the transceiver from the server, planned driving route information corresponding to the request information, wherein the planned driving route information indicates an adjusted autonomous driving path associated with the location of the vehicle.

12. The method of claim 11, further comprising, after the receiving of the planned driving route information, generating a control signal for controlling an updated autonomous driving operation of the vehicle using the planned driving route information.

13. The method of claim 11, further comprising, after the receiving of the planned driving route information:
converting the planned driving route information into at least one output format among a letter, a symbol, a figure, and a number; and
displaying, on a display device of the vehicle, the converted planned driving route information.

14. The method of claim 11, wherein the planned driving route information is provided by the server using an LLM model.

15. The method of claim 14, wherein the LLM model is configured to perform a training process, based on the vehicle driving information and the object recognition information, to generate the planned driving route information.

16. The method of claim 11, wherein the determining of the possibility of performing comprises:
determining, based on the vehicle driving information and the object recognition information, a performance probability for the autonomous driving operation control; and
determining, based on the performance probability being less than a threshold value, that performance of the autonomous driving operation control is not feasible.

17. The method of claim 16, wherein the transmitting of the request information comprises transmitting the request information, to the server via the transceiver, based on the performance probability being less than the threshold value.

18. The method of claim 17, wherein the determining of the performance probability comprises determining, based on a predetermined condition and using the vehicle driving information and the object recognition information, whether it is possible to perform the autonomous driving operation control.

19. The method of claim 11, wherein the determining of the possibility of performing comprises:
comparing a computing resource for performing the autonomous driving operation control with a threshold value; and
determining, based on the computing resource exceeding the threshold value, that performance of the autonomous driving operation control is not feasible.

20. The method of claim 19, wherein the transmitting of the request information comprises transmitting the request information based on the computing resource exceeding the threshold value.
